(19) United States
(12) Patent Application Publication
(10) Pub. No.: US 2020/0189251 A1
(43) Pub. Date: Jun. 18, 2020

(54) Electromagnetic Reduction Materials, Methods, and Devices

(71) Applicant: Breakwall Technology LLC, Westfield, IN (US)

(72) Inventors: Richard A. LUSIAK, Westfield, IN (US); John HOWARTER, West Lafayette, IN (US)

(21) Appl. No.: 16/801,585

(22) Filed: Feb. 26, 2020

Related U.S. Application Data
(63) Continuation-in-part of application No. PCT/US2018/048382, filed on Aug. 28, 2018.
(60) Provisional application No. 62/551,422, filed on Aug. 29, 2017.
(60) Provisional application No. 62/811,001, filed on Feb. 27, 2019.

(51) Int. Cl. B32B 27/20; B32B 9/04; B32B 27/30; B32B 27/38; B32B 25/16

(52) U.S. Cl. CPC B32B 27/20; B32B 9/045; B32B 9/043; B32B 27/308; B32B 2457/00; B32B 25/16; B32B 2264/10; B32B 2264/105; B32B 2307/212; B32B 27/38

(57) ABSTRACT

Electromagnetic protection devices and reduction materials which absorb ELF, electromagnetic protection devices comprising such materials, and methods for reducing ELF exposure are described herein.

### CROSS-REFERENCE TO RELATED APPLICATIONS

This application is a continuation-in-part of international application no. PCT/US2018/048382, filed on Aug. 28, 2018, which claims benefit of U.S. Provisional Application No. 62/551,422, filed on Aug. 29, 2017.

This application also claims benefit of U.S. Provisional Application No. 62/811,001, filed on Feb. 27, 2019.

The entire contents of international application no. PCT/US2018/048382, and of U.S. Provisional Application No. 62/811,001, are specifically incorporated by reference herein.

### BACKGROUND

Radiofrequency radiation from mobile phones, computers, and other electronic devices is becoming increasingly ubiquitous. Scientists and health professionals are increasingly concerned about the risks of such constant exposure, including, for example, from extremely-low frequency (ELF) magnetic fields. For example, the 2012 Bioinitiative Project, which was designed to identify standards for exposure to low-intensity electromagnetic radiation, concluded that childhood leukemia is associated with exposure to such radiation either during early life or in pregnancy. Extremely low frequency (ELF) electromagnetic radiation is therefore known to cause deleterious health effects and is a significant byproduct of the use of Wi-Fi routers and other electronic devices.

Indeed, as wireless communications technology advances, more and more devices are crowding the airwaves with electromagnetic radiation. For instance, energy companies now routinely install power meters at residential homes where powerful transmitters relay information about customer usage. Concerns about electromagnetic radiation from power meters have risen so much that some jurisdictions have considered banning them. Conventional shielding technologies deploy metals that while they reduce errant electromagnetic radiation at higher frequency, they do not perform well at reducing ELF magnetic fields, for example. In addition, their effectiveness at high frequency tends to degrade the intensity of desirable information signals such as at Wi-Fi carrier frequencies.

### SUMMARY

In one aspect of the disclosure, a composition comprising an electromagnetic reduction material and a polymer or glass is provided.

In another aspect of the disclosure, an electromagnetic protection device comprising an object capable of emanating electromagnetic radiation, an electromagnetic reduction material encompassing the object, said electromagnetic reduction material comprising an inorganic salt and a polymer or glass is provided.

In a further aspect of the disclosure, an electromagnetic reduction material comprising Himalayan salt and a polymer or glass is provided.

In yet a further aspect of the disclosure, an electromagnetic protection device comprising an object capable of emanating electromagnetic radiation, an electromagnetic reduction material encompassing the object, said electromagnetic reduction material comprising Himalayan salt and a polymer or glass, is provided.

In an additional aspect of the disclosure, a method of reducing electromagnetic radiation exposure from an object emanating electromagnetic radiation comprising encasing the object in an electromagnetic reduction material or device of the disclosure is provided.

In a further aspect of the disclosure, an object capable of emanating electromagnetic radiation and a polymer comprising between about 1% and about 20% Himalayan salt, wherein the electromagnetic radiation emanating from the object is reduced by the polymer is provided.

In yet a further aspect of the disclosure, an electromagnetic protection device comprising a multi-film layer of Himalayan salt and a polymer film is provided.

In a further aspect of the disclosure, an electromagnetic protection device comprising a polymer or glass blended with Himalayan salt is provided.

In yet another aspect of the disclosure, processes for preparing Himalayan salt-polymer solids comprising preparing a melt of a polymer and Himalayan salt and cooling the melt is provided.

### BRIEF DESCRIPTION OF THE FIGURES

FIG. 1 is a photograph of a layer of security film with a layer of Himalayan salt.

FIG. 2 is a photograph of a Wi-Fi router and an encasement of the disclosure.

FIG. 3 is a photograph of various acrylic encasements of the disclosure.

FIG. 4 is a photograph of an encasement of the disclosure.

FIG. 5 is a side-view photograph of an encasement of the disclosure.

FIG. 6 is a graph showing ELF response of an electromagnetic reduction material of the disclosure versus metal-based comparators.

FIG. 7 is a graph showing EHF response at 2.4 GHz of an electromagnetic reduction material of the disclosure versus a metal-based comparator.

FIG. 8 is a cross section of four film layers and Himalayan salt.

FIG. 9 is a schematic illustrating Himalayan salt film sheets surrounding an encasement.

FIG. 10 is an experimental set up showing the measurements taken in Example 7.

### DETAILED DESCRIPTION

An electromagnetic reduction material reduces the amount of electromagnetic radiation passing through it such, as for example, an object emanating electromagnetic radiation. The electromagnetic reduction materials of the disclosure include an inorganic salt comprising sodium salt, and in many embodiments is referred to as “Himalayan salt” or “Himalayan sea salt.” Himalayan salt is rock salt or halite from the Punjab region of Pakistan and is commercially available. It typically contains between about 95% to about 98% sodium chloride, between about 2% and 4% polyhalite (which contains potassium, calcium, magnesium, sulfur, oxygen, hydrogen), about 0.01% fluoride, about 0.01% iodine, and micro-amounts of numerous trace minerals. The salt crystals often have an off-white to transparent color, while impurities in some veins of salt may give it a pink, reddish, or beet-red color. As used herein, the term “Himalayan salt” does not require that the salt come from a specific region or geography, rather, that it be substantially the same composition as Himalayan salt that would be found in the Punjab region of Pakistan.

Electromagnetic reduction materials may also be said inorganic salts in combination with polymers or glass. When combined with a polymer, for example, such combinations may be in the form of sheets, encasements, plaques, or other solids. For example, the salt may be combined to form plaques that could be placed in front of an object or to encase an object in an encasement where electromagnetic reduction is desired. In many such embodiments, such inorganic salts are Himalayan salts.

Without being bound by theory, it is believed that the Himalayan salt acts as a selective absorber of electromagnetic radiation, including ELF. The Applicants have shown that electromagnetic reduction materials comprising Himalayan salt and devices made with such materials reduce and in many cases do not permit measurable extraneous and unwanted ELF radiation to pass, while at the same time permitting desired signals, such as from a Wi-Fi router, to pass. It is desirable to have an ELF absorbing material because of deleterious effects seen in exposure to ELF of intensities of only a few milligauss and higher.

Common Wi-Fi frequencies are at 2.4 GHz and 5 GHz and it is at about those frequencies that desirable data is transmitted. Generators of Wi-Fi signals, such as routers, produce radiation across a wide spectrum beyond simply the signal frequencies. For example, such devices produce ELF (extremely low frequencies) which are up to about 100 KHz and include other ranges including in the 3 to 300 Hz range. The objects and materials of the disclosure may be used to reduce ELF exposure.

In many embodiments, the Himalayan salt is adhered to the polymer or glass, often a polymer film. In such a film, the Himalayan salt may form a coating on the polymer. In some embodiments, there may be alternating layers of film sheets, such as polymer film sheets, with layers of Himalayan salt in between said alternating film sheets.

In many other embodiments, the Himalayan salt is combined with a polymer to form an object such as a plaque. Such plaques may be used alone or stacked together to act as electromagnetic reduction materials. The plaques may also be coated with one or more alternating layers of film sheets, such as polymer film sheets, with layers of Himalayan salt in between.

In other embodiments, the Himalayan salt is combined with a polymer or glass to form other solids such as an encasement. For example, the salt may be combined with a polymer at the melt temperature of the polymer and mixed and then cooled or injection molded into a solid. Injection molding may be done first by forming a different solid of the Himalayan salt and polymer such as a pellet. Ultimately, the solid formed may be in the form of an encasement. In some embodiments, the encasement polymer is acrylic. In some embodiments, the encasement polymer is PC/ABS. The encasement may then be placed around an object capable of emanating electromagnetic radiation. In many embodiments, when energized, the object emanates electromagnetic radiation and the encasement containing a polymer and Himalayan salt reduces the electromagnetic radiation, such as ELF, emanating from the object as it passes through the encasement.

Examples of polymers of the disclosure include crosslinked polyolefins, non-cross-linked polyolefins, Polyacrylic acid (PAA), Polyvinyl chloride, Polycarbonate-Acrylonitrile-Butadiene-Styrene blends, acrylic, polystyrene, low-density or high-density Polyethylene, Polypropylene, polystyrene, polylactic acid, poly-d-lactide, poly-l-lactide, regenerated cellulose, polyglycolic acid, plastarch material, polyhydroxybutyrate/polyhydroxyalkanoate, polycaprolactone, zein, shellac, lexan, eastman tritan, ethylene-propylene/ethylene-vinyl acetate copolymer/co-polyester/ethylene-vinyl acetate/ethylene-propylene copolymer, biaxially oriented polypropylene, nylons, teflon, polyethylene terephthalate, thermoplastic polyurethanes, mixtures of two or more of these, and mixtures of any one or more of these with one or more other polymers. Any such polymer or combination thereof may be used in conjunction with the Himalayan salt in accordance with the disclosure to reduce ELF exposure.

In embodiments where Himalayan salts are used in alternating layers with films (such as with polymer films) a typical thickness of a layer of Himalayan salt is on the order of about 1000 microns (1 mm being the particle size, for example on the label of some commercially available Himalayan salt). Typical layers of polymer film is on the order of 0.001 inches (254 microns) (a typical film being Gila® Safety and Security Film which is on the order of 0.001 inches thick). Thus, the combined thickness of such combinations is about 1254 microns. Other thicknesses of combinations are also available. For example, such thickness ranges include between about 25 microns and 250 microns, between about 250 and 500 microns, between about 500 microns and 1 millimeter, between about 1 millimeter and about 10 millimeters thick, and between 10 millimeters and 30 millimeters thick and all thicknesses in between. In many embodiments, the thickness of such a combination is at least 250 microns thick. In other embodiments, the thickness is at least 300 microns thick. In some embodiments, the thickness is between about 1000 microns and 2000 microns including between about 1000 microns and 1500 microns including between about 1200 microns and 1300 microns, and all values in between. In many embodiments, the number of combinations may be between 1 and 10 and any number in between such as 1 or at least 1 or 2 or at least 2. In particular any one of 1, 2, 3, 4, 5, 6, 7, 8, 9, or 10 combinations may be used in such embodiments.

The density of Himalayan salt on polymer films is often between about 0.1 grams per square inch and 1 gram per square inch including all values in between such as between about 0.3 and 0.5 grams per square inch and 0.4 grams per square inch. In some embodiments, the density is about 0.38 grams per square inch. The typical average thickness of the polymer film in Himalayan salt-polymer film combinations is between about 0.0001 and 0.1 inches including all values in between such as between about 0.001 and 0.1 inches and between about 0.001 and about 0.01 inches.

In many such embodiments where films are used, the polymer may be, for example, window insulation films such as a plastic film. A window insulation film is a plastic film which can be applied to glass windows to reduce heat transfer. There are two types in common use designed to reduce heat flow via radiation and convection respectively. Other films include solar control films or convection control films. A solar control film works by reflecting the infra-red component of solar energy (often 700 W/M²) and absorbing the UV component. Some films are also silvered or tinted to reduce visible light. Typical absorption for a silvered film is 65% for visible and infrared with 99% for UV. This type of film sticks may be used to stick directly onto glass.

A convection control film is a film attached to a window frame to trap a pocket of air between the glass and the film, creating a double-glazed system with an insulating gap of still air. Thermal conductivity of still air is 0.024 W/m/K and much lower than that of glass (0.96 W/m/K). Factors which limit the performance of a double glazed window are gap width, convection within the cavity and radiative heat transfer across the gap which is largely independent of its width. Optimal gap width depends on the temperature difference imposed across the gap. A European standard (EN 673) uses a 20° C. difference between the inside and outside temperature which results in a simulated gap width of about 17 mm for a standard double glazed window. A US standard (NFRC) uses a 39° C. difference which yields a smaller gap width of about 13 mm. Using the European standard a window with a gap of 17 mm has a simulated U-Value of about 2.8 W/m²/K, a window with a much smaller gap of 6 mm has a U-value of about 3.3 W/m²/K, while a single glazed window has a U-value of about 5.5 W/m²/K. The gap in such films is typically between about 1 and 100 mm thick.

The film may also be shrink wrapped, which can be useful when making an encasement with the film. The most commonly used shrink wrap is polyolefin, crosslinked, or non-cross-linked PVC, and Polyethylene Polypropylene. Co-extrusions and laminations are available for specific mechanical and barrier properties for shrink wrapping food. For example, five layers might be a configuration of EP/EVA/co-polyester/EVA/EP, where EP is ethylene-propylene and EVA is ethylene-vinyl acetate copolymer Also, biaxially oriented polypropylene (BOPP).

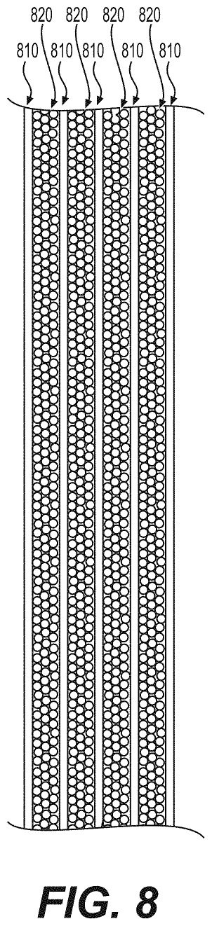

The films may be prepared, for example, as set forth in FIG. 8. Electromagnetic reduction material 820, such as Himalayan salt, may be adhered to polymer film 810 to form alternating film layers. The adherence may be done, for instance, with a polymer film that has an adhesive on one side to with 820 is added. The non-adhesive side of an 810 film layer may then be placed in contact with the Himalayan salt already adhered to a separate 810 polymer film. When the desired number of films are obtained, the resulting polymer film—Himalayan salt layer assembly may be arranged so as to encompass (for example, arranged so as to wrap around) one or more surfaces of a desired object which generates electromagnetic radiation so as to attenuate the radiation.

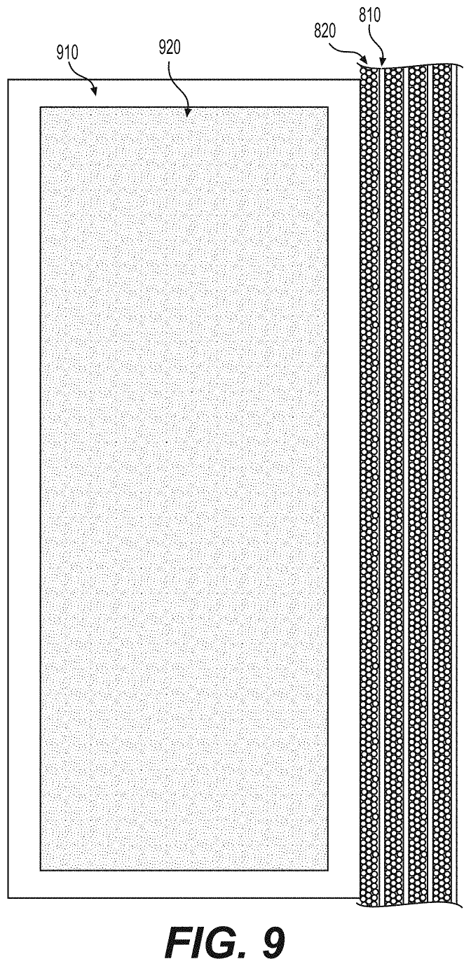

FIG. 9 illustrates the alternating polymer-film—Himalayan salt of FIG. 8 in a partial cross-section schematic. In that schematic, a source of electromagnetic radiation 920, such as a Wi-Fi router, is encased in a polymer encasement 910 which is enveloped by alternating polymer-film—Himalayan Salt layers, with the innermost layer being Himalayan salt. Four layers of each are illustrated in FIG. 9 on only one side of the encasement. Additional sides of the encasement may also be covered by said alternating polymer-film—Himalayan Salt layers, so that more or all sides (including bottom and top if desired) may be covered.

Glasses used in the disclosure include beveled glass, blown plate glass, bristol blue glass, burmese glass, carnival glass, cer-vit, chemically strengthened glass, chevron bead, crown glass (window), depression glass, factory tint, favrile glass, flat glass, float glass, flexible glass, foturan, frosted glass, fumed silica, fused quartz, glass fiber, glass microsphere, glass of antimony, glass wool, goldstone (glass), goofus glass, ground glass, heatable glass, hebron glass, hydrophobic silica, low-iron glass, moss agate glass, polished plate, glass, porous glass, prince rupert's drop, rippled glass, silica fiber, silica fume, silica gel, sitall, smart glass, temperature sensitive glass, tiffany glass, toughened glass, zerodur, Pyrex®, apache tears, australite, darwin glass, edeowie glass, fulgurite, georgiaite, glass with embedded metal and sulfides, impactite, lechatelierite, libyan desert glasslimu o pele, maskelynite, moldavite, obsidian, palagonite, pele's hair, pele's tears, pitchstone, rizalite, scoria, sea glass, tektite, trinitite, vitrified sand, and volcanic glass. examples of non-oxide glasses include aluminosilicate, amorphous carbonia, bioactive glass, bioglass, borophosphosilicate glass, borosilicate glass, ceramic glaze, cobalt glass, cranberry glass, crown glass (optics), dichroic glass, egyptian faience, flint glass, fluorophosphate glass, fluorosilicate glass, fused quartz, germanium dioxide, glass with embedded metal and sulfides, glass-ceramic-to-metal seals, glass-to-metal seal, ground granulated blast-furnace slag, jadeite (kitchenware), lead glass, leaded glass, low-dispersion glass, milk glass, opaline glass, phosphate glass, phosphorus pentoxide, phosphosilicate glass, photochromic lens, potassium silicate, reagent bottle, retroreflective sheeting, salt glaze pottery, soda-lime glass, sodium hexametaphosphate, sodium silicate, soluble glass, tellurite glass, tin glazing, ultra low expansion glass, underglaze, uranium glass, vitreous enamel, vitrite, waterglass, wood's glass, mixtures of two or more of these, and mixtures of any one or more of these with one or more other glasses.

In some embodiments, film layers of Himalayan salt and polymers such as Polyacrylic acid (PAA) are provided. A film comprising Himalayan salt and PAA may be prepared, for example, where the weight ratio of Himalayan salt is between about 1% and about 50% including between about 5% and about 40% and also between about 6.25% and about 33%. Such films may be prepared from solution, for example, to create a homogeneous solution from which the solvent, for example, water, may be evaporated to form a homogenous film.

In some embodiments, heterogenous film layers of Himalayan salt and polymer film, such as those prepared in Example 8, are provided. In these and other embodiments, Himalayan salt is placed as a layer in between polymer films. While PAA polymer films may be used, other polymers alone or in conjunction with PAA may be used. For example, Polybutylene succinate (PBS) may be used. PBS may be supplied in combination with other polymers such as in Polybutylene succinate-Polylactic acid (PBS-PLA), Polybutylene succinate Adipate-Polylactic acid (PBSA-PLA), Polybutylene succinate-talcum (PBS-talcum), Polybutylene succinate-Polybutylene adipate terephthalate (PBS-PBAT), Polybutylene succinate-Carbon nanotube (PBS-carbon nanotube), Polybutylene succinate-Polylactic acid-Calcium Sulfate Whiskers (PBS-PLA-CaSO4whiskers), N-butyl benzene sulfonamide (BBSA), and/or 1,4-butanediol (BDO).

There may be multiple layers of alternating layers of polymer film, such as PAA or any of the polymers set forth above, and Himalayan salt. For example there could be between 1 and about 20 layers of polymer films with Himalayan salts in between each or some of the polymer film layers. For example, there could be 2, 3, 4, 5, 6, 7, 8, 9, or 10 polymer film layers with a layer of Himalayan salt in between each polymer film layer. The combined thickness of the multiple alternating layers may be between about 400 microns and about 3000 microns with thicknesses in between. Examples of other ranges of thickness include between about 400 and 500 microns, between about 500 and 750 microns, between about 750 and 900 microns, between about 900 and about 1000 microns, and between about 1000 microns and 1100 microns for example.

TABLE 1

| | Film | | % Reduction mG |
|---|---|---|---|
| | thickness | | (average across |
| Example | in microns | Composition | 60-340 kHz) |
| 6 | 150 | Epoxy | 3.5 |
| 6 | 150 | 10% salt (Epoxy) | 3.7 |
| 16 | 160 | Aluminum foil | 59.9% |
| 16 | 320 | Aluminum foil | 71% |
| 16 | 640 | Aluminum foil | 78% |
| 16 | 960 | Aluminum foil | 81% |
| 9 | 150 | 6.25% salt | 2.4 |
| 9 | 150 | 16.67% salt | 6.0 |
| 9 | 150 | 33% salt | 10.0 |
| 10 | 450 | 3 layer system (53% salt) | 40.7 |
| 10 | 900 | 6 layer system (58%) salt | 81.1 |
| 11 | 150 | 20% Iron Chloride | 4.4 |
| 12 | 300 | 20% Iron Chloride (2 layer) | 10.6 |
| 13 | 150 | 20% nickel powder | 3.5 |
| 13 | 150 | 62% nickel powder | 11.2 |
| 13 | 150 | 62% iron powder | 13.0 |

Data summarized in Table 1 presents a percentage reduction in magnetic field as measured in mG averaged across 60-340 kHz range for each material composition set forth in the Table. Standard formulation epoxy, and epoxy with 10% Himalayan salt added (as described in Example 6) were used as control specimen (500 micron thick coupons) along with retail purchased aluminum foil (160 microns thick). The control epoxy with no added Himalayan salt showed a 3.5% mG reduction. The addition of Himalayan salt showed an improvement to 3.7% mG reduction. Aluminum foil had a 59.9% mG reduction at the 160 micron thickness.

Films of PAA-Himalayan salt showed a monotonic increase in magnetic field blocking as content of Himalayan salt was increased from 6.25% to 33%. At the highest content of Himalayan salt in Table 1, the 150 micron film was able to block 10% of the magnetic field. By incorporating the multilayer film approach and introducing the Himalayan salt in crystalline form (i.e. not as an aqueous solution) a material with 53% by weight Himalayan salt was able to block 40.7% of the magnetic field. This system had two layers of Himalayan salt sandwiched across three layers of PAA at a thickness of 450 microns. By increasing this formulation to create five layers of Himalayan salt sandwiched across six layers of PAA at a thickness of 900 microns, the system was able to block 81.1% of the magnetic field.

Films of PAA-iron chloride salt were prepared as described above in Example 11 and Example 12. At 20% iron chloride loading, the film was able to block 4.4% of the magnetic field. A single sandwiched iron chloride film (1 layer of iron chloride and 2 encapsulating layers of PAA) was able to block 10.6% of the magnetic field. The total amount of iron chloride for both specimens was equivalent.

The embodiments of Table 1 were also tested in their ability to pass Wi-Fi signals as set forth in Example 15 and Table 3.

The method to affix the electromagnetic reduction material of the disclosure, such as Himalayan salt, to glass encompasses either affixing the above-mentioned film to the interior side of the glass with an adhesive by itself or as adhered to a polymer film wherein the film is adhered to the glass or may be incorporated into the manufacturing process and sandwiched between multi-pane glass, which is routinely utilized in windows for energy conservation reasons.

In other embodiments, processes for incorporating electromagnetic reduction materials such as Himalayan salt into paints, stains and varnishes are provided. Paints include oil paints, varnish, enamel paints, lacquer paints, and latex paints. Stains include oil stain, varnish stain, water-based stain, gel stain, lacquer stain, water-soluble dye stain, and metal-complex (metalized) dye stain. Varnish includes violin, resin, shellac, alkyd, spar varnish, drying oils, polyurethane, lacquer, acrylic, two-part, and conversion.

The process for incorporating electromagnetic reduction materials, such as Himalayan salt, into paints and the other above-mentioned similar products includes either a liquid or powdered additive that can be mixed into the liquid paint or used as a primer prior to the paint application.

In many embodiments, the electromagnetic reduction material is combined with a polymer to form a solid such as a plaque or an encasement. Such combination may be done by conventional methods such as injection molding. Such polymers are those listed herein and include for example, PC-ABS. In these and other embodiments, the weight percent of the electromagnetic reduction material, such as Himalayan salt, is between 0.01% and 99.99% including between 0.1% and 99.9%, and between 1% and 99%, and between 2% and 98%, and between 1% and 15%, and between 15% and 30%, and between 30% and 45%, and between 45% and 60%, and between 60% and 75%, and between 75% and 90%, and between 90% and 99%.

More specifically, such embodiments include Himalayan salt with weight percents of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%.

In many embodiments, an object capable of emanating electromagnetic radiation is encased by an encasement wherein the encasement is attached to a combination of alternating Himalayan salt and polymer films of the disclosure. In other embodiments, the object capable of emanating radiation is encased in a polymer encasement comprising one or more polymers and between about 1% and about 20% Himalayan salt by weight including between about 5% and 20%. Such weight percents include about 2%, 3%, 4%, 5%, 6%, 7%, 8%, 9%, 10%, 11%, 12%, 13%, 14%, 15%, 16%, 17%, 18%, and 19%. The object to be encased may be encased on all sides or the base may be left unencased. When combined with the polymer, the Himalayan salt in these and other embodiments may be blended with the polymer by conventional methods.

In many embodiments of the disclosure, processes are disclosed for applying electromagnetic reduction materials comprising of Himalayan salt and a polymer or glass to electronic devices either directly to the housing of the electronic device or to a separate encasement that is configured to encompass the electronic device. The encasement may be configured to encompass a Wi-Fi box, cellular telephone, cable box, laptop or desktop computer, tablet computer, or any of various other electronic devices, and particularly those devices that emit radiation.

The expressions “encompass” and “encompassing” and variations of these terms as used herein include encompassing one or more surfaces of the electronic device and/or portions of such surfaces of the device. As an example for a six-sided device, this can include encompassing one or more sides, the top surface, the bottom surface, or combinations of these, or portions of these or combinations of portions of these. For example, for a Wi-Fi box, this can in one embodiment include encompassing its top surface and sides but not its bottom surface.

The electromagnetic reduction material, such as a Himalayan salt or a Himalayan salt combined with a polymer as described herein, may be attached to another material so as to form an encasement to encompass the electronic device. An encasement material may be another polymer such as an acrylic. Other encasement materials include the polymers set forth herein. It may be attached, for example, by using alternating Himalayan salt-polymer film assemblies where either Himalayan salt or a polymer film is in contact with the encasement.

In Examples 6, various solids in the form of plaques were prepared with various loadings of Himalayan salt by mass between 0 and about 20% by mass. In Example 7, several of the plaques so made were tested so as to determine the blocking ability of the plaques (not in encasements) via ELF in comparison to film layers. The results are shown in Table 2 below:

TABLE 2

| Material Composition | | Magnetic field | |
|---|---|---|---|
| Himalayan Salt | | (mGauss) | |
| Loading (wt %) | Matrix | 1 kHz | 100 kHz |
| 0% | air | 8.30 | 9.90 |
| 0% | epoxy | 3.44 | 3.54 |
| 1% | epoxy | 5.80 | 5.40 |
| 5% | epoxy | 2.08 | 3.03 |
| 20% | epoxy | 2.18 | 2.82 |

The data indicate that plaques of Himalayan salt are able to reduce ELF exposure at both 1 kHz and 100 kHz even when not encasing the object emanating or capable of emanating electromagnetic radiation.

In Table 3, the compositions of Table 2 are tested to determine whether they pass Wi-Fi signals at 2.4 GHz. As can be seen, aluminum as expected blocks a substantial portion of Wi-Fi signal (over 50%). None of the other test articles block Wi-Fi signals. For example, the multilayer polymer film of PAA and Himalayan salt, did not reduce Wi-Fi signal while at the same time did block low frequency electromagnetic radiation as set forth in Table 2. Indeed, the six-layer system of Table 2 had similar blocking capability as aluminum, but without the detrimental blocking of Wi-Fi signal in Table 3.

TABLE 3

| | Film | | |
|---|---|---|---|
| | thickness | | % Reduction mG |
| | in | | (average across |
| Example | microns | Composition | 60-340 kHz) |
| 6 | 150 | Epoxy | <1% |
| 6 | 150 | 10% salt (Epoxy) | <1% |
| 16 | 160 | Aluminum foil | 55% |
| 16 | 320 | Aluminum foil | 55% |
| 16 | 640 | Aluminum foil | 55% |
| 16 | 960 | Aluminum foil | 55% |
| 9 | 150 | 6.25% salt | <1% |
| 9 | 150 | 16.67% salt | <1% |
| 9 | 150 | 33% salt | <1% |
| 10 | 450 | 3 layer system (53% salt) | <1% |
| 10 | 900 | 6 layer system (58%) salt | <1% |
| 11 | 150 | 20% Iron Chloride | <1% |
| 12 | 300 | 20% Iron Chloride | <1% |
| | | (2 layer) | |
| 13 | 150 | 20% nickel powder | <1% |
| 13 | 150 | 62% nickel powder | <1% |
| 13 | 150 | 62% iron powder | <1% |

In these and other embodiments, the electromagnetic reduction material may be formed into other solid forms such as into pellets which may then be injection molded or extruded into desirable shapes such as to form encasements.

Objects that may be subject of encasement by the devices or electromagnetic reduction material of the disclosure include Wi-Fi routers, computers, cellular telephones, power meters, and other devices relying on radiofrequency signals. Other examples include consumer electronic devices.

The following clauses provide numerous embodiments and are non-limiting:

Clause 1. A composition comprising an electromagnetic reduction material and a polymer or glass.

Clause 2. An electromagnetic protection device comprising:
a. an object capable of emanating electromagnetic radiation,
b. an electromagnetic reduction material encompassing the object, said electromagnetic reduction material comprising an inorganic salt and a polymer or glass.

Clause 3. The electromagnetic reduction material of clause 2, wherein the inorganic salt comprises sodium chloride.

Clause 4. The electromagnetic reduction material of clause 2, wherein the inorganic salt is Himalayan salt.

Clause 5. The device of clauses 2-4, wherein the object is a power meter.

Clause 6. The device of clauses 2-4, wherein the object is a computer.

Clause 7. The device of clauses 2-4, wherein the object is a Wi-Fi emitting device.

Clause 8. The device of clause 7, wherein the object is a cellphone.

Clause 9. The device of clauses 2-4, wherein the object is a consumer electronic device.

Clause 10. An electromagnetic reduction material comprising Himalayan salt and a polymer or glass.

Clause 11. The electromagnetic reduction material of clause 10 wherein the Himalayan salt is adhered to the polymer or glass.

Clause 12. The electromagnetic reduction material of clauses 10-11, wherein the Himalayan salt is adhered to a polymer film.

Clause 13. The electromagnetic protection device of clauses 2-4, wherein the electromagnetic reduction material comprises a polymer or glass coated with a layer of Himalayan salt adhered to the polymer or glass.

Clause 14. The electromagnetic protection device of clauses 2-4, and 13, wherein the electromagnetic reduction material comprises a glass and Himalayan salt.

Clause 15. The electromagnetic protection device of clauses 4-9 wherein the inorganic salt is Himalayan salt and wherein there is at least one layer of said Himalayan salt and the polymer is a film adhered to at least one layer of Himalayan salt.

Clause 16. The electromagnetic reduction material of clauses 11-12, wherein the inorganic salt is Himalayan salt and wherein there are at least two layers of Himalayan salt and at least two layers of polymer film with a polymer film in between each Himalayan salt layer.

Clause 17. The electromagnetic reduction material of clauses 15-16, wherein each layer is at least 0.3 mm thick on average.

Clause 18. The electromagnetic reduction material of clauses 15-17, wherein there is at least 2 layers each of Himalayan salt and polymer film.

Clause 19. The electromagnetic reduction material of clause 18, wherein there are 3, 4, 5, 6, or 7 layers each of Himalayan salt and polymer film.

Clause 20. The electromagnetic reduction material of clause 19, wherein there are 4 layers with a density of Himalayan salt of between 0.1 and 1 g/in2.

Clause 21. The electromagnetic reduction material of clause 20, wherein the density of Himalayan salt is between about 0.3 and 0.5 g/in2.

Clause 22. The electromagnetic reduction material of clause 20, wherein the density of Himalayan salt is about 0.38 g/in2.

Clause 23. The electromagnetic reduction material of clause 19, wherein the polymer is a window film, plastic film, solar control film, shrink wrap, or a convection control film.

Clause 24. The electromagnetic reduction material of clause 23, wherein the film is silvered.

Clause 25. The electromagnetic reduction material of clause 23 or 24, wherein film is convection control film and comprises a glass and a polymer with an insulating gap of air.

Clause 26. The electromagnetic reduction material of clause 25, wherein the gap is between 1 mm and 100 mm thick.

Clause 27. The electromagnetic reduction material of clauses 2-26, wherein the polymer is selected from the group consisting of crosslinked polyolefins, non-cross-linked polyolefins, PVC, Polyethylene Polypropylene, ethylene-propylene/ethylene-vinyl acetate copolymer/co-polyester/ethylene-vinyl acetate/ethylene-propylene copolymer, Polycarbonate-Acrylonitrile-Butadiene-Styrene blends, biaxially oriented polypropylene, mixtures of two or more of these, and mixtures of any one or more of these with one or more other polymers.

Clause 28. The electromagnetic reduction material of clauses 10-26, wherein the thickness of the polymer film or glass is between 0.0001 and 1 inch thick.

Clause 29. The electromagnetic reduction material of clause 28, wherein the thickness of the polymer film or glass is between 0.001 and 0.1 inches thick.

Clause 30. The electromagnetic reduction material of clause 28, wherein the thickness of polymer film or glass is between 0.01 and 0.1 inches thick.

Clause 31. The electromagnetic reduction material of clauses 10-30 wherein further comprising an encasement.

Clause 32. The electromagnetic reduction material of clause 31, wherein the encasement is an acrylic material.

Clause 33. The electromagnetic material of clause 32, wherein the encasement is a polymer.

Clause 34. The electromagnetic material of clause 33, wherein the polymer is PC/ABS.

Clause 35. The electromagnetic material of clause 33, wherein the polymer of the encasement is selected from crosslinked polyolefins, non-cross-linked polyolefins, Polyvinyl chloride, Polycarbonate-Acrylonitrile-Butadiene-Styrene blends, acrylic, polystyrene, low-density or high-density Polyethylene, Polypropylene, polystyrene, polylactic acid, poly-d-lactide, poly-l-lactide, regenerated cellulose, polyglycolic acid, plastarch material, polyhydroxybutyrate/polyhydroxyalkanoate, polycaprolactone, zein, shellac, lexan, eastman tritan, ethylene-propylene/ethylene-vinyl acetate copolymer/co-polyester/ethylene-vinyl acetate/ethylene-propylene copolymer, biaxially oriented polypropylene, nylons, teflon, polyethylene terephthalate, thermoplastic polyurethanes, mixtures of two or more of these, and mixtures of any one or more of these with one or more other polymers.

Clause 36. The electromagnetic reduction material of clauses 10-35, wherein the weight percentage of Himalayan salt is between 0.01% and 99.99%.

Clause 37. The electromagnetic reduction material of clauses 10-36, wherein the weight percentage of Himalayan salt is between 0.1% and 99.9%.

Clause 38. The electromagnetic reduction material of clause 37, wherein the weight percentage of Himalayan salt is between 1% and 99%.

Clause 39. The electromagnetic reduction material of clause 38, wherein the weight percentage of Himalayan salt is between 2% and 98%.

Clause 40. The electromagnetic reduction material of clauses 10-37, wherein the weight percentage of Himalayan salt is between 1% and 15%.

Clause 41. The electromagnetic reduction material of clauses 10-35, wherein the weight percentage of Himalayan salt is between 15% and 30%.

Clause 42. The electromagnetic reduction material of clauses 10-35, wherein the weight percentage of Himalayan salt is between 30% and 45%.

Clause 43. The electromagnetic reduction material of clauses 10-35, wherein the weight percentage of Himalayan salt is between 45% and 60%.

Clause 44. The electromagnetic reduction material of clauses 10-35, wherein the weight percentage of Himalayan salt is between 60% and 75%.

Clause 45. The electromagnetic reduction material of clauses 10-35, wherein the weight percentage of Himalayan salt is between 75% and 90%.

Clause 46. The electromagnetic reduction material of clauses 10-35, wherein the weight percentage of Himalayan salt is between 90% and 99%.

Clause 47. The electromagnetic reduction material of clauses 10-35, wherein the weight percentage of Himalayan salt is about 1%, 2%, 3%, 4%, 5%, 6%, 7%, 8%, 9%, 10%, 11%, 12%, 13%, 14%, or 15%.

Clause 48. The electromagnetic reduction material of clauses 10-35, wherein the weight percentage of Himalayan salt is about 16%, 17%, 18%, 19%, 20%, 21%, 22%, 23%, 24%, 25%, 26%, 27%, 28%, 29%, or 30%.

Clause 49. The electromagnetic reduction material of clauses 10-35, wherein the weight percentage of Himalayan salt is about 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%.

Clause 50. An electromagnetic protection device comprising:
a. an object capable of emanating electromagnetic radiation,
b. an electromagnetic reduction material encompassing the object, said electromagnetic reduction material comprising Himalayan salt and a polymer.

Clause 51. The electromagnetic protection device of clause 52 wherein the polymer is PC/ABS.

Clause 52. The electromagnetic protection device of clause 54, wherein the weight percentage of Himalayan salt is between 0.001% and 99.99% by weight.

Clause 53. A method of reducing electromagnetic radiation exposure from an object emanating electromagnetic radiation comprising encasing the object in an electromagnetic reduction material of clauses 3-4 and 10-52.

Clause 54. An electromagnetic protection device comprising:
a. an object capable of emanating electromagnetic radiation,
b. a polymer comprising between about 1% and about 20% Himalayan salt, wherein the electromagnetic radiation emanating from the object is reduced by the polymer.

Clause 55. The electromagnetic protection device of clause 54, wherein the polymer is in the form of a plaque.

Clause 56. An electromagnetic protection device comprising a polymer comprising between about 1% and about 20% Himalayan salt.

Clause 57. The electromagnetic protection device of clauses 54-56, wherein the weight percent of Himalayan salt is between about 5% and about 20%.

Clause 58. An electromagnetic protection device comprising a multi-film layer of Himalayan salt and a polymer film.

Clause 59. The electromagnetic protection device of clause 58, wherein there is one Himalayan salt film and one polymer film.

Clause 60. The electromagnetic protection device of clause 58, wherein there is at least 2 films of Himalayan salt with a polymer film layer in between each layer of Himalayan salt.

Clause 61. The electromagnetic protection device of clause 60, wherein there are 4 layers of Himalayan salt.

Clause 62. The electromagnetic protection device of clauses 58-61, wherein each combined layer of Himalayan salt and polymer film is independently between about 25 microns and about 250 microns.

Clause 63. The electromagnetic protection device of clauses 58-61, wherein each combined layer of Himalayan salt and polymer film is independently between about 250 microns and about 500 microns.

Clause 64. The electromagnetic protection device of clauses 58-61, wherein each combined layer of Himalayan salt and polymer film is independently between about 500 microns and about 1 mm.

Clause 65. The electromagnetic protection device of clauses 58-61, wherein each combined layer of Himalayan salt and polymer film is independently between about 1 mm and about 10 mm.

Clause 66. The electromagnetic protection device of clauses 58-61, wherein each layer of Himalayan salt and polymer film is independently between about 10 mm and about 30 mm.

Clause 67. The electromagnetic protection device of clauses 58, 60 and 62-66, wherein there are 1, 2, 3, 4, 5, 6, 7, 8, 9, or 10 layers of Himalayan salt with polymer films in between layers of Himalayan salts.

Clause 68. The electromagnetic protection device of clauses 50-52, 54, 57 wherein the Himalayan salt is combined with the polymer in an encasement and wherein the object is within the encasement.

Clause 69. The electromagnetic protection device of clauses 50-52, 54, 57 wherein the polymer encases the object.

Clause 70. The electromagnetic protection device of clause 68, wherein the encasement covers the object on all sides of the object other than the base of the object.

Clause 71. The electromagnetic protection device of clause 68, wherein the encasement covers the object on all sides of the object.

Clause 72. An electromagnetic protection device comprising a polymer or glass wherein Himalayan salt is blended with the polymer or glass.

Clause 73. The electromagnetic protection device of clause 72, wherein the percent by mass of Himalayan salt is between about 1% and about 20%.

Clause 74. The electromagnetic protection device of clause 72, wherein the percent by mass of Himalayan salt is between about 5% and about 20%.

Clause 75. The electromagnetic protection device of clause 74, wherein the percent by mass of Himalayan salt is about 10%.

Clause 76. A process for preparing Himalayan salt-polymer solids comprising preparing a melt of a polymer and Himalayan salt and cooling the melt.

Clause 77. The electromagnetic material of clauses 60-76, wherein the polymer is selected from crosslinked polyolefins, non-cross-linked polyolefins, Polyvinyl chloride, Polycarbonate-Acrylonitrile-Butadiene-Styrene blends, acrylic, polystyrene, low-density or high-density Polyethylene, Polypropylene, polystyrene, polylactic acid, poly-d-lactide, poly-l-lactide, regenerated cellulose, polyglycolic acid, plastarch material, polyhydroxybutyrate/polyhydroxyalkanoate, polycaprolactone, zein, shellac, lexan, eastman tritan, ethylene-propylene/ethylene-vinyl acetate copolymer/co-polyester/ethylene-vinyl acetate/ethylene-propylene copolymer, biaxially oriented polypropylene, nylons, teflon, polyethylene terephthalate, thermoplastic polyurethanes, mixtures of two or more of these, and mixtures of any one or more of these with one or more other polymers.

Clause 78. An electromagnetic reduction material comprising two or more layers of a polymer film with Himalayan salt in between at least two layers of polymer film.

Clause 79. The electromagnetic reduction material of clause 78, wherein the number of polymer film layers is between 3 and 20.

Clause 80. The electromagnetic reduction material of clause 79, wherein the number of polymer film layers is between 3 and 10.

Clause 81. The electromagnetic reduction material of clause 80, wherein the number of polymer film layers is 6.

Clause 82. The electromagnetic reduction material of clauses 77-81, wherein Himalayan salt is placed in between each polymer film layer.

Clause 83. The electromagnetic reduction material of clauses 77-82, wherein the polymer film is PAA.

Clause 84. The electromagnetic reduction material of clauses 77-82, wherein each polymer film is independently selected from PAA, PBS, Polybutylene succinate-Polylactic acid (PBS-PLA), Polybutylene succinate Adipate-Polylactic acid (PBSA-PLA), Polybutylene succinate-talcum (PBS-talcum), Polybutylene succinate-Polybutylene adipate terephthalate (PBS-PBAT), Polybutylene succinate-Carbon nanotube (PBS-carbon nanotube), Polybutylene succinate-Polylactic acid-Calcium Sulfate Whiskers (PBS-PLA-CaSO4whiskers), N-butyl benzene sulfonamide (BBSA), and 1,4-butanediol (BDO).

Clause 85. An electromagnetic protection device comprising: an object capable of emanating electromagnetic radiation, and an electromagnetic reduction material of clauses 77-84.

### Examples

### Example 1—Adhering Himalayan Salt to a Window Film

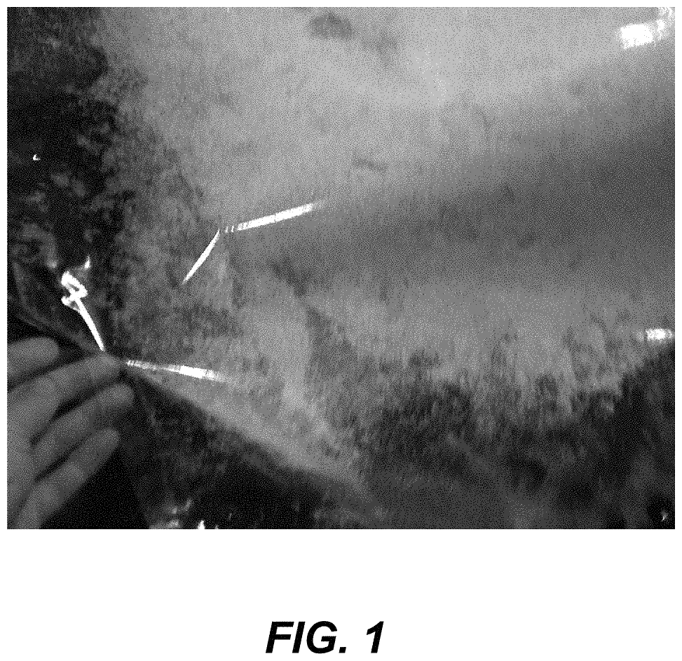

The process of adhering salts to window films was performed with use of multiple layers of security film designed for shatter-proofing windows. The security film utilized was Gila® Safety and Security Film, clear in color, (see, e.g., U.S. Pat. No. 4,075,386) comprising a polyurethane stratum interposed between a pair of polyester strata, each of which is self-supporting, with the minor surface of the film comprising a pressure sensitive adhesive (PSA). Each PSA layer comprises a pressure sensitive adhesive to bond the Himalayan salt to each layer. One major surface of each layer is bonded to one opposite minor surface of the next subsequent layer such that the Himalayan salt is sandwiched between each layer. The thickness of the Himalayan salt being 0.001 inches. A photograph of a resulting film-salt base material (i.e., Himalayan salt) is set forth in FIG. 1.

### Example 2—ELF Performance

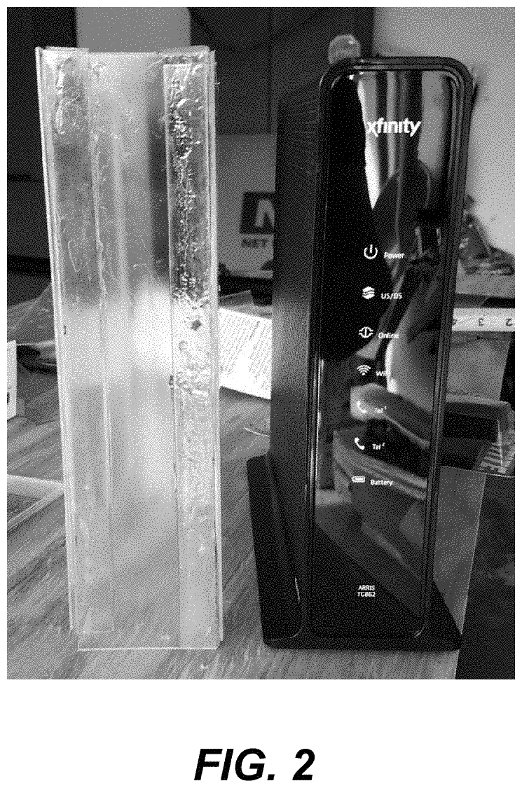

The film of Example 1 was applied to an acrylic box structure designed to encase a Wi-Fi router to test the ability of the salt to block both extremely low frequency (ELF) and extremely high frequency (EHF) signals emanating from the router. The acrylic utilized was 0.050 Non-Glare Acrylic (manufactured by Plaskolite, Inc., Plexiglas® MC UF-5). The router tested was an Arris TG 862 dual band (2.4 and 5.0 GHz) Xfinity cable Wi-Fi router operating at full power on each channel as seen in FIG. 2.

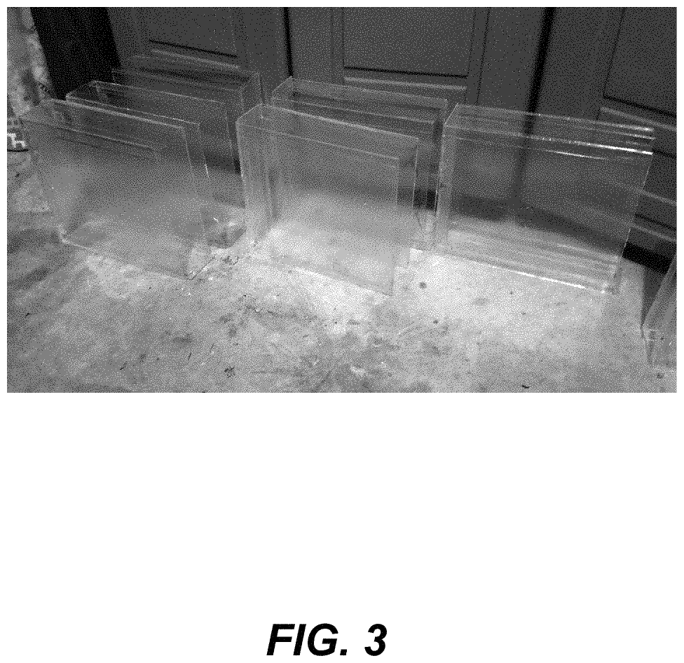

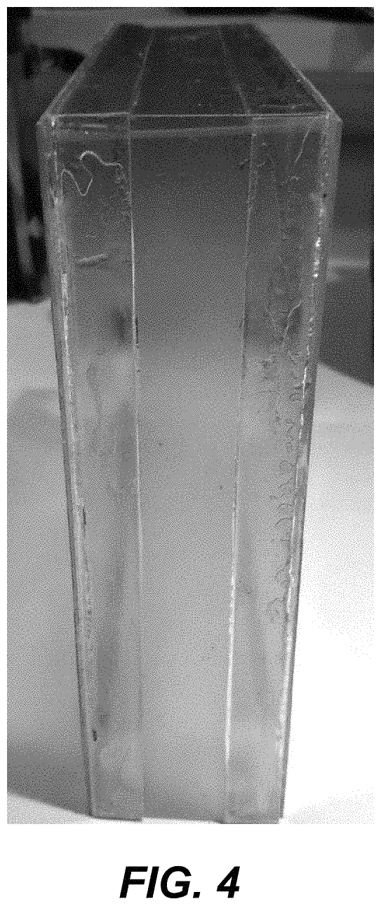

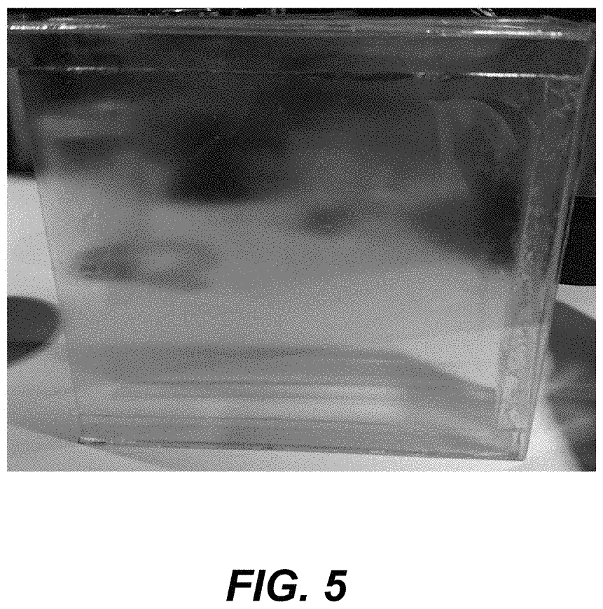

Multiple acrylic encasements were constructed, as shown in FIG. 3. A total of 7 encasements were made (the seventh box is seen on the lower right-hand-side of FIG. 3). The encasements in FIG. 3 were subsequently wrapped with polymer film layers and Himalayan salt layers in between. The Himalayan salts used had a typical particle size on the order of about 1 mm as indicated on the label. When making films, the salt was applied evenly to the adhesive surface of each film in the amount of about 0.38 grams per square inch. When attaching the films to the acrylic encasements, the first encasement was wrapped with one layer of film with salt adhered. Each subsequent encasement was wrapped with an initial layer of film with salt adhered and an additional layer of film with salt adhered. Thus, box 2 had 2 such layers (two of each salt an polymer film), box 3 with 3 such layers, etc. The structures measured 9 5/16″×8¼″×2 3/16″. Each layer of film was measured by a General No. 102, 0-1 inch .001 Caliper, and measured 0.001 inches (about 25 microns) per layer. FIG. 4 shows one example encasement and FIG. 5 shows another example encasement from a different perspective.

Measurements were taken using a TriField® Meter, Model 100XE of both ELF and EHF with an acrylic box that was not wrapped with a layer of film. The measurements for ELF were over 100 milligauss prior to implementing any layers of film as a barrier. The tests were then performed with a layer of film added for each additional test. Measurements were taken of the first box comprising one layer of the Himalayan salt material and the ELF reduced 10 fold to 10 milligauss. It may be noted that while substantially reducing the amount of ELF, it was still possible to transmit data to and from the router for, e.g., checking e-mail, etc.

The next box was measured comprising 2 layers of Himalayan salt with ELF measuring 3.5 milligauss. The third box was measured comprising 3 layers of salt with ELF measuring 1.5 milligauss. At four layers, ELF was not measurable, and the transmission of the EHF (the WiFi signal) was only minutely affected.

### Example 3—Preparation of Router Encasements Containing Himalayan Salts (Prophetic)

Polycarbonate-Acrylonitrile-Butadiene-Styrene Blends (AB/PC S) are prepared with Himalayan salts at concentrations of various concentrations ranging from 1% to 99%. Blends are slow or fast-injection molded at sufficient temperatures to make desired encasements.

### Example 4 Testing Router Encasements of the Disclosure

An Arris Surboard Dual band router was measured with a TriField® Meter Model 100XE meter for ELF measurements. In an AB/PCS blend containing Himalayan salts which was injected molded so as to encase the router. Concentrations from about 5% to about 20% were made. The following measurements were done on the about 10% Himalayan salt loading encasement. With the router turned on, but without a cover, the ELF was “pinned” to the highest value of the trimeter which was 100 milligauss. After putting the cover on the router, the ELF was reduced to 0.7 milligauss over the course of several hours. Upload and download speeds were measured using an app called “SPEEDTEST” (by Ookla®) and on average (three phones and two laptops) found to have a download speed of 45 Megabits/second without an encasement and 42 Megabits/second with an encasement. Without an encasement, the average upload speed was measured to be 11.1 Megabits/second which lowered to 10.1 Megabits/second with an encasement.

### Example 5—Head-to-Head Comparisons Between Encasements of the Disclosure and Commercially Available Shielding Devices

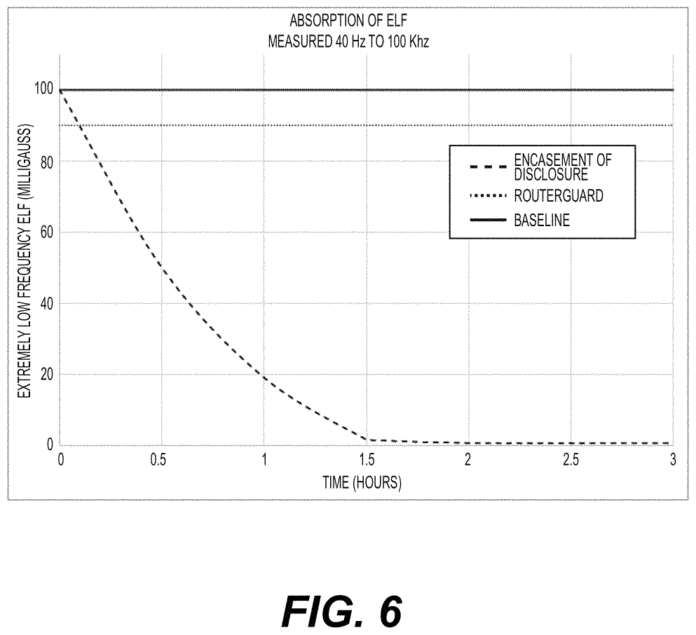

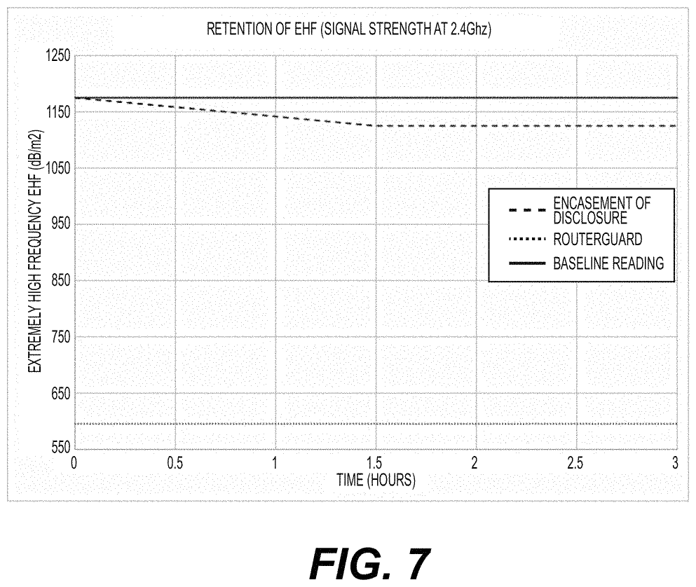

Encasements without Himalayan salts were prepared and used to encompass an Arris Surboard Dual Band Wi-Fi Router using the about 10% loading of Example 4. Both ELF, measured at between 40 Hz and 100 KHz, and EHF at 2.4 GHz were measured using a TriField® Meter Model 100XE. A Router Guard® was purchased, which is a metal mesh cage sold commercially, as a comparator. In the comparison experiments, the router was placed inside the Router Guard device. Without any encasement or Router Guard as shown in FIG. 6, ELF was found to be over 100 milligauss. With the Router Guard, ELF was only slightly reduced to slightly over 90 milligauss. By comparison, with an encasement of the disclosure, ELF reduced to 1.5 milligauss after 1.5 hours and to 0.6 milligauss after 3 hours. With regards to EHF, Wi-Fi signal at 2.4 GHz was only nominally reduced to 1125 db/square meter from 1175 whereas with Router Guard, EHF was reduced from 1175 db/square meter to 596 dB/square meter as set forth in FIG. 7.

### Example 6—Polymer Epoxy Plaques of Himalayan Salt

Positive plaque molds made out of modeling board material (RenShape™) with dimensions of 4×4×0.15 in plaques were sketched using computer aided drawing software (Autodesk® Fusion 360™). The molds were sanded prior to use. Mold negatives were prepared by using a heat resisting silicone formulation (Mold Max 60™); the flexible silicone mold was prepared by rapidly stirring a mixture of liquid precursor chemical (“Part A”, primarily short chain silicone molecules with crosslinkable reactive sites) and liquid curing agent (“Part B”, primarily crosslinking agent, catalyst, and diluent) together in a 1000 mL beaker. The mixture was prepared at a ratio of 100A:3B. Specifically, Part A was about 450-500 grams, with a corresponding amount of part B of 13.5-15 grams. Mixing was done until a uniform red color was achieved in the mixture (a few minutes typically) and then poured into the prepared positive RenShape mold. The mold was left to cure for about 24 hours and a spatula was used to slowly release the silicone from the positive mold, resulting in a silicone negative mold for epoxy. The silicone mold negatives were made to contain liquid epoxy during epoxy curing and ensure the appropriate dimensions of the final epoxy materials.

The silicone mold was sprayed with one coat of Smooth-On universal mold release and placed in the oven at about 80° C. for 10 minutes. While the mold was in the oven, the epoxy mixture was formulated and prepared for curing in the mold. Three primary components were mixed: a common difunctional epoxide, diglycidyl ether of bisphenol A (DGEBA), a phenolic based curing agent (GP® 2074 from Georgia Pacific), and Himalayan salt in a plastic container was measured out so that the total mass was between 45 and 50 grams (depending on loading), with the GP2074 mixed at a ratio of 2:3 with the DGEBA, and the salt content at the correct concentration. The mixture was placed in the dual asymmetric centrifugal laboratory mixer (a Speedmixer™ by FlackTek Inc.) and mixed at 1600 rpm in three 3-minute cycles with a 30 second break between each cycle. During this mixing, the silicone mold was removed from the oven and the oven temperature was increased to the epoxy curing temperature of 130° C. The mold was sprayed with a second coat of mold release and the mixture from the Speedmixer™ was added into a 250 mL glass beaker which was then placed in a circulating silicone oil bath at 65° C. for 12 minutes.

The temperature on the oil bath up was increased to 130° C. The silicone mold was sprayed again with universal mold release. The beaker was removed from the oil bath at 123° C. and poured into the silicone mold and placed in the oven. A temperature program was run in the oven as follows: 130° C. for 2 hours, then increase to 140° C., and hold at 140° C. for 2 hours, increase to 145° C., and hold at 145° C. for 2 hours, increase to 160° C. and hold at 160° C. for 2 hours, followed by a 4 hour cooling to room temperature. The cured polymer composite material housed in the silicone mold were taken out of the oven and the composite material was removed from the silicone. The composite material was then sanded until the color lightened to a transparent pink and ripples in the surface were removed.

### Example 7—Measurement of Blocks of Example 6 and Examples 9-13

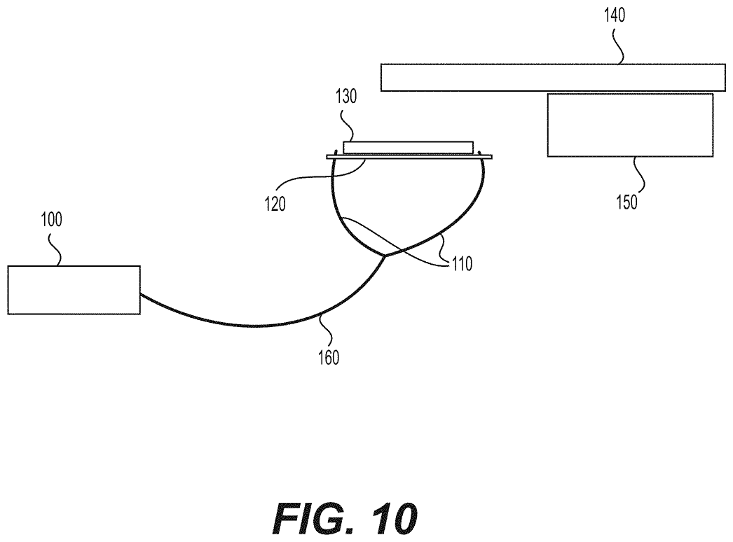

The plaques of Example 6 and Examples 9-13 were measured as set forth in FIG. 10. Signal generator 100 swept 1-100 kHz (1-340 kHz in Examples 9-13) every 20 seconds while set to 20V. Lead line 160 from the signal generator were covered by rubber wire with alligator clips attached at the end to connect copper wire 120 to lead lines 110. Copper wire 102 was approximately 15 cm in length and was placed on a surface. A 10 cm by 10 cm epoxy plaque test article, 103, was placed on top of copper wire 102. An Aaronia AG NF-5035 sensor for recording the magnetic field in milligauss between 1 kHz and 100 kHz (1-340 kHz for Examples 9-13) and attached to a computer with the Aaronia NF program so that the computer recorded the magnetic field data was placed over test article 103 in a cantilevered position and was supported by insulating support 105 which was a dry erase eraser.

### Example 8—PAA—Base Solutions/Films

10 grams of Polyacrylic acid (PAA) as solid polymer pellets sourced from Sigma Aldrich (product number 306215, molecular weight viscosity-based 1,250,000 g/mol), were dissolved in deionized water at a concentration of 2% (weight %) PAA at room temperature for at least 24 hours with a magnetic stirring bar.

### Example 9 Homogenous PAA—Salt Films

25 grams of Himalayan salt was dissolved in deionized water at concentrations of 5% salt by weight. To create PAA-Himalayan salt composite films, PAA solutions described in Example 8 were mixed with Himalayan salt solutions for an effective final weight % of Himalayan salt ranging from 6.25%-33% (i.e. PAA:Himalayan salt ratio of 16:1-3:1) as set forth in Table 2. Solutions were mixed for 30s in a FlackTek mixer at 800 rpm, followed by a 30 second break in mixing, followed by a 3 minute cycle at 1600 rpm. To create films, a total of 30 grams of the combined PAA-Himalayan salt solution was poured into a 6 cm diameter plastic disposable petri dish and the water from the salt solution was evaporated for 24 hours at room temperature in a fume hood. The resulting films were 150 microns thick +/−10 microns. Specimen film thickness was measured using digital calipers taking at least 5 measurements at various locations in the film. The dehydrated films were removed from the petri dish and tested according to the protocol described in Example 7.

### Example 10—Heterogeneous PAA—Salt Films

PAA-salt films with alternating layers of Himalayan salt were prepared as follows. To create PAA-Himalayan salt multilayer materials, 30 grams of PAA solution described in Example 8 was deposited into a 6 cm diameter plastic petri dish. The solution was dehydrated for 24 hours in a fume hood and 1 gram of Himalayan salt was added to the top of the dehydrated PAA film and remained undisturbed for 3 hours. Following, another 30 grams of PAA solution was poured on top of the dehydrated film and Himalayan salt and the entire system was dehydrated at room temperature in a fume hood for 24 hours. This cycle repeats with one more layer of Himalayan salt and one final layer of PAA solution deposited to create a film stack with three layers of PAA and two layers of Himalayan salt with a composition of 58% by weight Himalayan salt. Additional multilayer films were created using the same methods and repeating the sequence until a material comprised of six layers of PAA and five layers of Himalayan salt was created with a composition of 58% by weight Himalayan salt. Based on this formulation and processing protocol, the resulting films were 450 microns thick and 900 microns thick +/−10 microns for the three and six layer PAA films respectively. Specimen film thickness was measured using digital calipers taking at least 5 measurements at various locations in the film. The dehydrated films were removed from the petri dish and the free-standing films were tested according to the protocol described in Example 7.

### Example 11—Iron Chloride Additives to PAA-Films

10 grams of iron chloride salt was dissolved in deionized water at concentrations of 2.3% salt by weight. To create PAA-iron chloride films, PAA solutions described above were mixed with iron chloride solutions for an effective final weight % of iron chloride salt of 20% (i.e. PAA:iron chloride salt ratio of 5:1). Solutions were mixed for 30s in a FlackTek mixer at 800 rpm, followed by a 30 second break in mixing, followed by a 3 minute cycle at 1600 rpm. To create the films, a total of 30 grams of the combined PAA-iron chloride salt solution was poured into a 6 cm diameter plastic disposable petri dish, water evaporated from the solution for 24 hours at room temperature in a fume hood. Based on this formulation and processing protocol, the resulting films were 150 microns thick +/−10 microns. Specimen film thickness was measured using digital calipers taking at least 5 measurements at various locations in the film. The dehydrated films were removed from the petri dish and the free-standing films were tested according to the protocol described in Example 7.

### Example 12—PAA-Iron Chloride Multilayer Materials

To create PAA-iron chloride multilayer materials, 30 grams of PAA solution described in Example 8 was deposited into a 6 cm diameter plastic petri dish. The solution was dehydrated for 24 hours in a fume hood and 0.45 grams of iron chloride salt was added to the top of the dehydrated PAA film and remained undisturbed for 3 hours. Another 30 grams of PAA solution was then poured on top of the dehydrated film and iron chloride salt and the entire system was dehydrated at room temperature in a fume hood for 24 hours. Based on this formulation and processing protocol, the resulting films were 300 microns thick +/−10 microns. Specimen film thickness was measured using digital calipers taking at least 5 measurements at various locations in the film. The dehydrated films were removed from the petri dish and the free-standing films were tested according to the protocol described in Example 7.

### Example 13—PAA-Metal Particle Films of Fe and Ni

Iron powder was acquired from Goodfellow Corp. and was reported as 99.0%+ purity with a maximum particle diameter of 450 microns. Nickel powder was acquired from Sigma Aldrich and was reported as 99.7%+ purity with a maximum particle diameter of 50 microns. To create PAA-metal particle films, PAA solutions were mixed with metallic powder particles with a PAA:particle ratio of 5:3 or 5:1. To prepare solutions for casting, 30 grams of PAA solution described in Example 8 was mixed with between 0.6-1.8 grams of single element metallic powder (specifically, either iron powder or nickel powder was used) to produce the desired PAA:particle ratio. Powder suspensions were mixed using an ultrasonicator for 3 min with 10s mixing cycles with 10s breaks at 40% amplitude. The suspension was then poured into a 6 cm diameter plastic disposable petri dish, water evaporated from the solution for 24 hours at room temperature in a fume hood. Based on this formulation and processing protocol, the resulting films were 150 microns thick +/−10 microns. Specimen film thickness was measured using digital calipers taking at least 5 measurements at various locations in the film. The dehydrated films were removed from the petri dish and the free-standing films were tested according to the protocol described in Example 7.#

### Example 14—Iron and Nickel Films Properties

Iron and nickel powders were used as compositional additives to polymer films as described in Example 13. At 20% loading, nickel-based films were able to block 3.5% of the magnetic field. At 62% loading, nickel-based films were able to block 11.2% of the magnetic field and at 62% loading, iron-based films were able to block 13.0% of the magnetic field. These films were 150 microns thick. On a mass-normalized basis, the iron chloride salt and the Himalayan salt were able to outperform the metal powder samples. Further, enhanced magnetic field blocking was observed when introducing Himalayan salt or iron chloride salt using a heterogeneous-PAA system.

### Example 15—Router Testing

The router tested was an Arris TG 862 dual band (2.4 and 5.0 GHz) Xfinity cable Wi-Fi router operating at full power on each channel. To perform the test, the back side of router was turned toward the magnetic field meter. Samples were placed on a stand 2 inches tall in front of router between router and meter. Magnetic field test was run from 2.399 GHz to 2.499 GHz. Router data was collected. No test material presented here was able to block the router signal within our measurement detection limit (1% change for this frequency range).

### Example 16—Tests of Aluminum Strips

Aluminum foil (retail purchase, Reynolds brand) was used as a control sample for blocking magnetic field. The aluminum foil was measured to be 160 microns thick. The aluminum foil was cut in 6 inch by 6 inch squares and was stacked as 1 layer, 2 layer, 4 layer, and 6 layer free standing stacks. Each stack was tested according to the protocol described in Example 7.

1-53. (canceled)

54. An electromagnetic protection device comprising:
a. an object capable of emanating electromagnetic radiation,
b. a polymer comprising between about 1% and about 20% Himalayan salt, wherein the electromagnetic radiation emanating from the object is reduced by the polymer.

55. The electromagnetic protection device of claim 54, wherein the polymer is in the form of a plaque.

56-57. (canceled)

58. An electromagnetic protection device comprising a multi-film layer of Himalayan salt and a polymer film.

59. The electromagnetic protection device of claim 58, wherein there is one Himalayan salt film and one polymer film.

60. The electromagnetic protection device of claim 58, wherein there is at least 2 films of Himalayan salt with a polymer film layer in between each layer of Himalayan salt.

61. The electromagnetic protection device of claim 60, wherein there are 4 layers of Himalayan salt.

62. The electromagnetic protection device of claim 58, wherein each combined layer of Himalayan salt and polymer film is independently between about 25 microns and about 250 microns thick.

63-64. (canceled)

65. The electromagnetic protection device of claim 59, wherein each combined layer of Himalayan salt and polymer film is independently between about 1 mm and about 10 mm thick.

66-77. (canceled)

78. An electromagnetic reduction material comprising two or more layers of a polymer film with Himalayan salt in between the at least two layers of polymer film.

79. The electromagnetic reduction material of claim 78, wherein the number of polymer film layers is between 3 and 20.

80. The electromagnetic reduction material of claim 78, wherein the number of polymer film layers is between 3 and 10.

81. The electromagnetic reduction material of claim 79, wherein the number of polymer film layers is 6.

82. The electromagnetic reduction material of claim 78, wherein Himalayan salt is placed in between each polymer film layer.

83. (canceled)

84. The electromagnetic reduction material of claim 78, wherein each polymer film is independently selected from PAA, PBS, Polybutylene succinate-Polylactic acid (PBS-PLA), Polybutylene succinate Adipate-Polylactic acid (PBSA-PLA), Polybutylene succinate-talcum (PBS-talcum), Polybutylene succinate-Polybutylene adipate terephthalate (PBS-PBAT), Polybutylene succinate-Carbon nanotube (PBS-carbon nanotube), Polybutylene succinate-Polylactic acid-Calcium Sulfate Whiskers (PBS-PLA-CaSO4whiskers), N-butyl benzene sulfonamide (BBSA), and 1,4-butanediol (BDO).

85. An electromagnetic protection device comprising:
a. an object capable of emanating electromagnetic radiation,
b. an electromagnetic reduction material of claim 84.

86. The electromagnetic protection device of claim 59, wherein each combined layer of Himalayan salt and polymer film is independently between about 25 microns and about 250 microns thick.

87. The electromagnetic protection device of claim 60, wherein each combined layer of Himalayan salt and polymer film is independently between about 25 microns and about 250 microns thick.

88. The electromagnetic protection device of claim 61, wherein each combined layer of Himalayan salt and polymer film is independently between about 25 microns and about 250 microns thick.

89. The electromagnetic reduction material of claim 79, wherein Himalayan salt is placed in between each polymer film layer.
